(19) United States
(12) Patent Application Publication
(10) Pub. No.: US 2001/0054393 A1
(43) Pub. Date: Dec. 27, 2001

(54) Implement for successively receiving and/or treating individual animals out of a group of animals and a method of increasing the utilization capacity of the implement

(75) Inventor: Alexander Van der Lely, Na Rotterdam (NL)

Correspondence Address: Penrose Lucas Albright, Esq., MASON, MASON & ALBRIGHT, P.O. Box 2246, Arlington, VA, 22202-0246, US

(73) Assignee: LELY RESEARCH HOLDING AG,

(21) Appl. No.: 09/880,119

(22) Filed: Jun. 14, 2001

(30) Foreign Application Priority Data
Jun. 14, 2000 (NL) 1015435

(51) Int. Cl. A01K 1/00

(52) U.S. Cl. 119/416

(57) ABSTRACT

An implement for successively receiving and/or treating individual animals out of a group of animals which are allowed to move about freely in an area intended therefor and which are allowed individually to visit the implement, such as for example a concentrate feeding station and/or a milking robot, is provided with means for stimulating the animals to visit the implement. The implement is further provided with means for recording and/or determining a (possibly periodically recurring) time interval in which the expected visiting frequency of the group of animals to the implement is below a low threshold value, respectively above a high threshold value, and with means for extra stimulation, respectively less stimulation of the animals to visit the implement. By purposeful extra or less stimulation of the animals to visit the implement, there can be achieved a less varying visiting frequency in the course of time.

The invention relates to an implement as described in the preamble of claims 1, 2, 3, 4, 5 and 6. The invention further relates to a method of increasing the utilization capacity of such an implement.

Such an implement is known. The animals can for example be fed or milked in the implement. In order to ensure that the animals visit the implement sufficiently often, there are provided means for stimulating this. Said means comprise for example an implement for supplying concentrate. The known implement has inter alia the disadvantage that in certain periods too few animals visit the implement. This may result in longer waiting times for the animals at other points of time. In other periods too many animals wish to visit the implement. It is both in the interest of the animals and the user of the implement that the visits of the animals to the implement are spread as homogeneously as possible over the time.

The invention aims at improving such an implement. According to the invention this is achieved by the measures indicated in the characterizing part of claim 1 or claim 2 or claim 3 or claim 4 or claim 5 or claim 6. The invention is based on the insight that, by purposeful extra or less stimulation of the animals to visit the implement, there can be achieved a less varying visiting frequency in the course of time.

The measures indicated in the characterizing part of claim 1 respectively claim 2 enable extra respectively less stimulation of the animals to visit the implement during a known or to be determined appropriate time interval. The measures indicated in the characterizing part of claim 3 respectively claim 4 make it possible immediately to react adequately when the visiting frequency has been too low respectively too high for a while. The measures indicated in the characterizing part of claim 5 respectively claim 6 make it possible to determine, repeatedly if required, the visiting frequency pattern and to choose, on the basis thereof, a constantly optimal time interval for extra stimulation respectively less stimulation of the animals.

The invention will be explained in further detail with reference to some examples.

An implement, such as a concentrate feeding station and/or a milking robot for example, is suitable for successively receiving and/or treating individual animals out of a group of animals which are allowed to move about freely in an area intended therefor and which are allowed to visit the implement individually. The implement is provided with means, such as a concentrate feeding box for example, for stimulating the animals to visit the implement.

According to an aspect of the invention, the implement is further provided with means for recording and/or determining a (possibly periodically recurring) time interval in which the expected visiting frequency of the group of animals to the implement is below a low threshold value (respectively above a high threshold value), and with means for activating, during said time interval, means for extra (respectively less) stimulation of the animals to visit the implement.

The time interval with the lower (respectively higher) visiting frequency may be known from tests or from professional literature and be recorded in the implement (e.g. be stored in a computer). The time interval can also be determined, e.g. by means of a computer which disposes of relevant (historical and/or measured) reference data. For example, a weather station can supply data in relation to particular weather conditions or weather changes upon which the animals have appeared to be less (respectively more) inclined to visit the implement in a coming time interval. The use of a milking robot also enables extra (respectively less) stimulation of the animals for a while, after a cleaning pause. The low threshold value (respectively the high threshold value) may have a fixed value or may be a percentage of the average visiting frequency. A control device such as a computer can activate the means for extra (respectively less) stimulation of the animals during the time interval. Said means may comprise for example a reservoir with fodder or drink which is very attractive to the animals (respectively fodder or drink with is little attractive to the animals), the computer being suitable for actuating a metering device.

According to another aspect of the invention, the implement is further provided with means for establishing that the visiting frequency of the group of animals to the implement has been below a predetermined (possibly adjustable) low threshold value (respectively above a predetermined high threshold value) during a predetermined (possibly adjustable) period of time, and with means for activating in that case means for extra (respectively less) stimulation of the animals to visit the implement. The former means may comprise a computer which registers the visiting frequency. The latter means have already been elucidated in the foregoing.

According to again another aspect of the invention, the implement is further provided with means for determining the visiting frequency pattern of the group of animals to the implement in the course of time, means for determining a (possibly periodically recurring) time interval in which the visiting frequency of the animals to the implement is lower than a low threshold value (respectively higher than a high threshold value), and means for (periodically) activating, during the predetermined time interval, means for extra (respectively less) stimulation of the animals to visit the implement. The former means may again comprise a computer with the aid of which the visiting frequency pattern is measured. The latter means have already been elucidated in the foregoing. The visiting frequency may for example become very low every 24 hours around three o'clock in the morning. To counteract this, the computer can activate the means for extra stimulation every night from 2.30 to 3.30 a.m. If desired, the visiting frequency pattern can be measured again at intervals of a month for example. It is possible (e.g. because of habituation of the animals) that there will then be found another periodically recurring time interval for extra stimulation of the animals. As a result of the repeated measurements the optimal time interval will always be found.

The means for extra (respectively less) stimulation may be designed so as to be periodically activable and deactivable. The implement may further be provided with an animal identification system in which the means for extra (respectively less) stimulation on the basis of data from the animal identification system set the nature and/or the duration and/or the intensity of the extra (respectively less) stimulation for each individual animal that visits the implement and is recognized. There may be supplied for example an extra big portion of concentrate when the implement is visited by an animal which has a high milk production or an animal which has not visited the implement for a long time already. In such a situation, upon supplying extra attractive feed at the beginning of the visit during a predetermined period of time, it is also possible to prolong said predetermined period of time.

As already described in the foregoing, the means for extra (respectively less) stimulation may comprise a unit for feeding and/or watering an animal that visits the implement, said unit being provided in the implement, as well as a control device, such as a computer, and a metering device for the unit, said metering device being controllable by the control device. The control device may be suitable for actuating the metering device in such a manner that the latter, upon extra (respectively less) stimulation of the animals, supplies a larger (respectively smaller) amount of concentrate than normally. The control device may also be suitable for actuating the metering device in such a manner that the latter, upon extra (respectively less) stimulation of the animals, supplies fodder and/or drink which is extra attractive (respectively less attractive) to the animals.

The implement may be provided with means for giving a signal to the animals at least upon activation of the means for extra (respectively less) stimulation of the animals. This may draw the attention of the animals for example to the presence of the extra stimulus. The signal may be for example an audio signal or a visual or audio-visual signal which is given at the beginning of the time interval or during (a part of) the time interval.

In a method of increasing the utilization capacity of an implement as described above, such as a concentrate feeding station and/or a milking robot, the following steps are taken at least once or repeatedly:

determining the visiting frequency pattern of the group of animals to the implement in the course of time;

determining a (possibly periodically recurring) time interval in which the visiting frequency of the animals to the implement is lower than a low threshold value;

(periodically) extra stimulation of the animals to visit the implement during the predetermined time interval.

The advantages of repeatedly taking the above-mentioned steps have already been indicated in the foregoing: the implement is independently able to determine repeatedly the optimal time interval and to take, in said time interval, the measures required.

1. An implement for successively receiving and/or treating individual animals out of a group of animals which are allowed to move about freely in an area intended therefor and which are allowed individually to visit the implement, such as for example a concentrate feeding station and/or a milking robot, said implement being provided with means for stimulating the animals to visit said implement, characterized in that the implement is provided with means for recording and/or determining a (possibly periodically recurring) time interval in which the expected visiting frequency of the group of animals to the implement is below a low threshold value, and with means for activating, during said time interval, means for extra stimulation of the animals to visit the implement.

2. An implement for successively receiving and/or treating individual animals out of a group of animals which are allowed to move about freely in an area intended therefor and which are allowed individually to visit the implement, such as a concentrate feeding station and/or a milking robot, said implement being provided with means for stimulating the animals to visit said implement, characterized in that the implement is provided with means for recording and/or determining a (possibly periodically recurring) time interval in which the expected visiting frequency of the group of animals to the implement is above a high threshold value, and with means for activating, during said time interval, means for less stimulation of the animals to visit the implement.

3. An implement for successively receiving and/or treating individual animals out of a group of animals which are allowed to move about freely in an area intended therefor and which are allowed individually to visit the implement, such as for example a concentrate feeding station and/or a milking robot, said implement being provided with means for stimulating the animals to visit said implement, characterized in that the implement is provided with means for establishing that the visiting frequency of the group of animals to the implement has been below a predetermined low threshold value during a predetermined period of time, and with means for activating in that case means for extra stimulation of the animals to visit the implement.

4. An implement for successively receiving and/or treating individual animals out of a group of animals which are allowed to move about freely in an area intended therefor and which are allowed individually to visit the implement, such as a concentrate feeding station and/or a milking robot, said implement being provided with means for stimulating the animals to visit said implement, characterized in that the implement is provided with means for establishing that the visiting frequency of the group of animals to the implement has been above a predetermined high threshold value during a predetermined period of time, and with means for activating in that case means for less stimulation of the animals to visit the implement.

5. An implement for successively receiving and/or treating individual animals out of a group of animals which are allowed to move about freely in an area intended therefor and which are allowed individually to visit the implement, such as a concentrate feeding station and/or a milking robot, said implement being provided with means for stimulating the animals to visit said implement, characterized in that the implement is provided with means for determining the visiting frequency pattern of the group of animals to the implement in the course of time, means for determining a (possibly periodically recurring) time interval in which the visiting frequency of the animals to the implement is lower than a low threshold value, and means for (periodically) activating, during the predetermined time interval, means for extra stimulation of the animals to visit the implement.

6. An implement for successively receiving and/or treating individual animals out of a group of animals which are allowed to move about freely in an area intended therefor and which are allowed individually to visit the implement, such as a concentrate feeding station and/or a milking robot, said implement being provided with means for stimulating the animals to visit said implement, characterized in that the implement is provided with means for determining the visiting frequency pattern of the group of animals to the implement in the course of time, means for determining a (possibly periodically recurring) time interval in which the visiting frequency of the animals to the implement is higher than a high threshold value, and means for (periodically) activating, during the predetermined time interval, means for less stimulation of the animals to visit the implement.

7. An implement as claimed in any one of claims 1, 3 and 5, characterized in that the means for extra stimulation are capable of being activated and deactivated periodically.

8. An implement as claimed in any one of claims 2, 4 and 6, characterized in that the means for less stimulation are capable of being activated and deactivated periodically.

9. An implement as claimed in any one of claims 1, 3, 5 and 7, characterized in that the implement is provided with an animal identification system and that, on the basis of data from the animal identification system, the means for extra stimulation adjust the nature and/or the duration and/or the intensity of extra stimulation for each individual animal that visits the implement.

10. An implement as claimed in any one of claims 2, 4, 6 and 8, characterized in that the implement is provided with an animal identification system and that, on the basis of data from the animal identification system, the means for less stimulation adjust the nature and/or the duration and/or the intensity of less stimulation for each individual animal that visits the implement.

11. An implement as claimed in any one of claims 1, 3, 5, 7 and 9, characterized in that the means for extra stimulation comprise a unit for feeding and/or watering an animal that visits the implement, said unit being provided in the implement, as well as a control device, such as a computer, and a metering device for the unit, said metering device being controllable by the control device.

12. An implement as claimed in any one of claims 2, 4, 6, 8 and 10, characterized in that the means for less stimulation comprise a unit for feeding and/or watering an animal that visits the implement, said unit being provided in the implement, as well as a control device, such as a computer, and a metering device for the unit, said metering device being controllable by the control device.

13. An implement as claimed in claim 11 or 12, characterized in that the control device is suitable for actuating the metering device in such a manner that the latter, upon extra respectively less stimulation of the animals, supplies a larger respectively a smaller amount of concentrate than normally.

14. An implement as claimed in any one of claims 11 to 13, characterized in that the control device is suitable for actuating the metering device in such a manner that the latter, upon extra respectively less stimulation of the animals, supplies fodder and/or drink which is extra attractive to the animals, respectively fodder and/or drink which is less attractive to the animals.

15. An implement as claimed in any one of claims 1 to 14, characterized in that the implement is provided with means for giving a signal to the animals at least upon activation of the means for extra (respectively less) stimulation of the animals.

16. A method of increasing the utilization capacity of an implement, such as for example a concentrate feeding station and/or a milking robot, for successively receiving and/or treating individual animals out of a group of animals which are allowed to move about freely in an area intended therefor and which are allowed individually to visit the implement, characterized in that the following steps are taken at least once or repeatedly:
determining the visiting frequency pattern of the group of animals to the implement in the course of time;
determining a (possibly periodically recurring) time interval in which the visiting frequency of the animals to the implement is lower than a low threshold value;
(periodically) extra stimulation of the animals to visit the implement during the predetermined time interval.
